(19) United States
(12) Patent Application Publication
(10) Pub. No.: US 2006/0286238 A1
(43) Pub. Date: Dec. 21, 2006

(54) Processes for isolating bitter quinides for use in food and beverage products

(75) Inventors: Gerhard Norbert Zehentbauer, Okeana, OH (US); Paul Ralph Bunke, Cincinnati, OH (US); Athula Ekanayake, Cincinnati, OH (US); Jerry Douglas Young, Cincinnati, OH (US); Oliver Frank, Muenster (DE); Thomas Frank Hofmann, Muenster (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/156,883

(22) Filed: Jun. 20, 2005

(51) Int. Cl. A23L 1/22

(52) U.S. Cl. 426/534

(57) ABSTRACT

Processes for isolating bitter quinides for use in food and beverage products entailing contacting a bitter quinide solution with an adsorbent to adsorb bitter quinides from the bitter quinide solution, desorbing the bitter quinides from the adsorbent to obtain a bitter quinide isolate, and adding the bitter quinide isolate to a food or beverage product to enhance the flavor thereof. A bitter quinide isolate made up of at least one of 3-O-caffeoyl-γ-quinide, 4-O-caffeoyl-γ-quinide, 5-O-caffeoyl-epi-δ-quinide, 5-O-caffeoyl-muco-γ-quinide, 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-muco-γ-quinide, 5-O-feruloyl-epi-δ-quinide, quinide esterified with one or more of caffeic acid, ferulic acid, p-courmaric acid, 2,4-dimethoxycinnamic acid and mixtures thereof.

### FIELD OF THE INVENTION

The present invention relates to processes for isolating bitter quinides for use in food and beverage products to enhance the flavors thereof.

### BACKGROUND OF THE INVENTION

Aside from its stimulatory effect, the popularity of freshly brewed coffee beverages is largely due to consumers' enjoyment of the alluring aroma, as well as the attractive and well-balanced taste profile, which is characterized by a unique, coffee-specific bitterness. In general, when present in low levels, the compounds responsible for bitterness may help reduce the acidity of the coffee while simultaneously providing body and dimension. However, if the concentration of bitter compounds becomes too low the fragile balance between aroma, sourness, bitterness and astringency becomes imbalanced, thereby resulting in less desirable flavor attributes. Similarly, if the concentration becomes too high, the bitterness compounds may overshadow the other taste components present in the coffee beverage, again resulting in an undesirable flavor. Because certain coffee beverages, such as instant and decaf, tend to have much lower concentrations of bitter compounds, these beverages are often characterized as having an unpleasant, weak flavor by consumers.

The foregoing bitter compounds are commonly known as bitter quinides, and generally comprise bitter mono- and di-caffeoyl quinides, caffeoyl-feruloyl quinides, and mono- and di-feruloyl quinides. Bitter quinides are derived from roasted chlorogenic acid, or more specifically, roasted mono-, di-, or tri-caffeoyl quinic acids, mono-, di-, or tri-feruloyl quinic acids, or corresponding quinic acids containing caffeoyl and feruloyl residues, that have been roasted under controlled conditions to form quinides upon intramolecular water elimination as well as intermolecular transesterification The bitter flavor profile of these quinides is unique when compared to other known bitter and sour flavorants found in coffee, such as caffeine, L-phenylalanine, 2,5-diketopiperazines as well as quinic and phosphoric acids.

In general, bitter quinides have a distinct, coffee-like “clean” bitterness and astringency while the other flavorants tend to display a sour, acidic flavor. For example, while bitter quinides provide bitterness combined with a slight astringency on the palate, such bitterness disappears rapidly after swallowing, thus resulting in a clean bitter perception. In contrast, the bitterness of caffeine is a “harsh” bitterness that produces an unpleasant lingering bitter aftertaste that remains in the throat for an extended period of time after swallowing.

While the existence of some bitter quinides is generally known, their molecular basis is far less understood. Indeed, to date, there is very little information available about the structure of the bitter compounds that provide this distinctive bitter flavor. Moreover, much of the information that is known tends to focus on methods for identifying and removing the bitter compounds from intensely bitter coffee products to provide more balanced coffee beverages that appeal to a broader base of consumers.

For instance, four bitter quinides were recently identified as compounds having a bitter flavor in a methanolic extract of soluble coffee. See, Ginz, M. and Engelhardt, U. H. “Analysis of Fractions of Roasted Coffee by LC-ESI-MS: New Chlorogenic Acid Derivatives,” Colloque Scientifigue International sur le Café, 19^{th} ed, 248-252, (2001). However, in spite of the work that has been done, there is currently no known process for isolating bitter compounds for use in food and beverage products as such use requires the compounds to be prepared in a food-grade manner. See, Food Chemicals Codex, 5^{th} Ed., The National Academies Press, Washington D.C., (2004) pgs. xxix-xxxii. The methanolic extract discussed above is not considered to be a food-grade preparation as methanol is highly toxic and, therefore, only permitted to be present in small amounts in certain products, such as spice oleoresins and hops. See, FDA Code of Regulations §173.250.

One explanation for the lack of a food-grade bitter quinide isolation process is the fact that, as mentioned above, in the past, researchers have been looking solely for ways to reduce the bitterness of intensely bitter coffees. In such cases, the bitter compounds are generally considered waste products that are disposed of after removal. However, if processes were developed to isolate the bitter compounds in a food-grade manner, the compounds could then be used to supplement and enhance the flavor of food and beverage products in a variety of ways never before considered. Such processes would simultaneously reduce the wasting of these bitter compounds while providing a way to enhance the flavor, body and character of other food and beverage products, as will be described herein.

Therefore, there remains a need for processes for isolating bitter quinides such that the bitter quinides may be added to food and beverage products to enhance the flavors thereof.

### SUMMARY OF THE INVENTION

In one embodiment, the present invention relates to processes for isolating bitter quinides for use in food and beverage products comprising: a. contacting a bitter quinide solution with an adsorbent to adsorb bitter quinides from the bitter quinide solution; b. desorbing the bitter quinides from the adsorbent to obtain a bitter quinide isolate; and c. adding the bitter quinide isolate to a food or beverage product to enhance the flavor thereof.

In another embodiment, the present invention relates to bitter quinide isolates for enhancing the flavor of food and beverage products, the bitter quinide isolates comprising at least one compound selected from the group consisting of 3-O-caffeoyl-γ-quinide, 4-O-caffeoyl-γ-quinide, 5-O-caffeoyl-epi-δ-quinide, 5-O-caffeoyl-muco-γ-quinide, 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-muco-γ-quinide, 5-O-feruloyl-epi-δ-quinide, quinide esterified with one or more of caffeic acid, ferulic acid, p-courmaric acid, 2,4-dimethoxycinnamic acid and mixtures thereof.

### DETAILED DESCRIPTION OF THE INVENTION

### Definitions

As used herein, the term “adsorbent” refers to any food-grade material capable of selectively adsorbing bitter quinides from a bitter quinide solution and includes, but is not limited to, polyamide, nylon powder, polyvinyl pyrrolidone, polyvinyl polypyrrolidone, casein, zein, Amberlite® XAD, natural or synthetic polymers containing amide groups and combinations thereof.

As used herein, the term “bitter quinide(s)” is used to generally describe any bitter quinides, including those compounds of the bitter quinide isolate, derived from roasting chlorogenic acid.

As used herein, the term “bitter quinide isolate” is used to refer to the compounds obtained by the present processes regardless of the method by which they are obtained. For instance, the bitter quinide isolate may be obtained via batch extraction, column isolation or any other known method known to those skilled in the art. The bitter quinide isolate generally comprises at least one compound selected from the group consisting of 3-O-caffeoyl-γ-quinide, 4-O-caffeoyl-γ-quinide, 5-O-caffeoyl-epi-δ-quinide, 3-O-feruloyl-γ-quinide, 4-O-feruloyl-γ-quinide, 3,4-O-dicaffeoyl-γ-quinide, 4-O-caffeoyl-muco-γ-quinide, 5-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O -feruloyl-muco-γ-quinide, 5-O-feruloyl-epi-δ-quinide, quinide esterified with one or more of caffeic acid, ferulic acid, p-courmaric acid, 2,4-dimethoxycinnamic acid, combinations thereof and mixtures thereof. When used to enhance the flavor of a food or beverage product, the bitter quinide isolate does not include any naturally occurring bitter quinides that may be present in the food or beverage product being enhanced.

As used herein, the term “bitter quinide solution” means a solution comprising bitter quinides for use in the processes of the present invention. The bitter quinide solution comprises at least one roasted chlorogenic acid derived from natural or synthetic acid sources.

As used herein, the term “chlorogenic acid(s)” means any free acid derived from natural or synthetic acid sources selected from the group consisting of monocaffeoyl quinic acids, dicaffeoyl quinic acids, tricaffeoyl quinic acids, monoferuloyl quinic acids, diferuloyl quinic acids, triferuloyl quinic acids, quinic acid esterified with one or more of caffeic acid, ferulic acid, p-courmaric acid, 2,4-dimethoxycinnamic acid. Chlorogenic acids, whether derived from natural sources or synthetically, form bitter quinides when roasted as described herein.

As used herein, the term “comprising” means various components can be cojointly employed in the methods and articles of this invention. Accordingly, the terms “consisting essentially of” and “consisting of” are embodied in the term comprising.

As used herein, the term “food-grade” means that the material may legally be used as part of the unit operations of a food process or, that contact with a food is approved by regulatory authorities. The term “food-grade manner” means using a material such that it satisfies the foregoing regulatory requirements.

As used herein, the term “natural acid source” means a plant material comprising chlorogenic acid. “Natural acid source” includes, but is not limited to, coffee beans, banana leaves, potatoes, apples, pineapples, cherries, peaches and combinations thereof.

As used herein, the term “residual bitter quinide solution” means the components of the bitter quinide solution that are not adsorbed by the adsorbent, which generally includes any non-phenolic organic or inorganic material, (e.g. citric acid, quinic acid, malic acid, phosphoric acid), minerals (e.g. sodium, potassium), caffeine, and coffee odorants.

As used herein, the term “roasting” refers to the process of heating any of the foregoing acids or acid sources, whether natural or synthetic, under the same general conditions as are employed when roasting green coffee beans. The roasting may be performed at ambient or elevated pressure and the roasting temperature may be constant or follow a desired curve (e.g. ramping). The acids or acid sources may be roasted independently or they may be mixed with an inert material, such as, for example, cellulose.

As used herein, the term “solvent” means any food-grade solvent including, but not limited to, water, ethanol, acetone, ethyl acetate and mixtures thereof. When used in the desorption step of the present processes, the solvent may further include any solvent capable of selective removal of bitter quinides from an adsorbent.

Bitter Quinides

The present invention provides methods for isolating bitter quinides for use in food and beverage products comprising contacting a bitter quinide solution with an adsorbent to adsorb bitter quinides from the bitter quinide solution; desorbing the bitter quinides from the adsorbent to obtain a bitter quinide isolate; and adding the bitter quinide isolate to a food or beverage product to enhance the flavor thereof. While the following discussion will generally be directed at the identification, isolation and use of isolated bitter quinides in coffee beverages, it will be understood by those skilled in that art that this use of coffee is done for illustration purposes only and the invention should not be limited to such.

As aforementioned, several bitter quinides are known to be present in roasted coffee, including 3-O-caffeoyl-γ-quinide, 4-O-caffeoyl-γ-quinide, 5-O-caffeoyl-epi-δ-quinide and 5-O-caffeoyl-muco-γ-quinide. See, for example, Ginz, supra. However, while the existence of these bitter quinides is discussed in the art, prior to the work of the present inventors, the true bitter character of many of these compounds was unknown. Moreover, the present inventors discovered that the chemical structure of at least two of the aforementioned compounds is not accurately described in the art, as will be explained below. 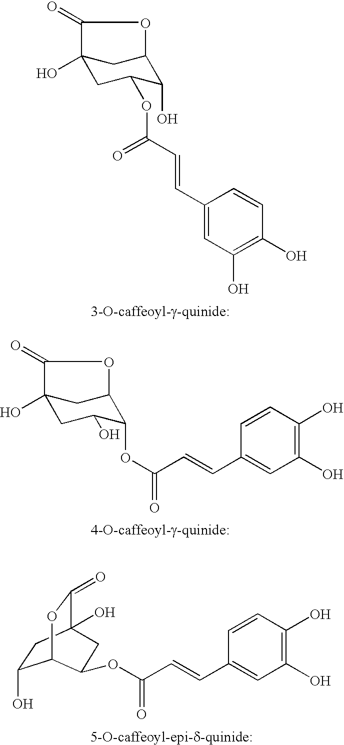
5-O-caffeoyl-epi-δ-quinide is discussed in the Ginz reference, however, the reference incorrectly identifies the C-3 hydroxyl group as being located in the equatorial position when the present inventors have discovered that that C-3 hydroxyl group is, in fact, located in the axial position (shown above). This is important as stereochemistry is one of the key factors for determining the flavor activity of a compound. 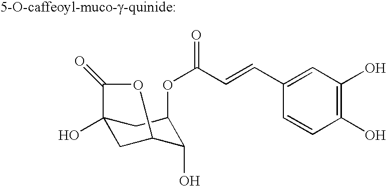
Again, 5-O-caffeoyl-muco-γ-quinide is discussed in the Ginz reference, however, the reference incorrectly identifies the C-5 caffeic acid group as being located in the equatorial position when the present inventors have discovered that that C-5 caffeic acid group is, in fact, located in the axial position (shown above). Once again, this is an important difference as stereochemistry helps determine the flavor activity of a compound.

In addition to the foregoing known bitter quinides, the present inventors have discovered several more varieties. In particular, the present inventors have recently identified 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-muco-γ-quinide and 5-O-feruloyl-epi-δ-quinide, as bitter quinides. These newly discovered bitter quinides are distinct from the previously described bitter compounds in that they generally have a more complex substitution pattern and their stereochemistry is different from the known compounds, which, as aforementioned, is important to the determination of flavor activity. While some of these compounds have been discussed generally in the art as being present in coffee extracts, their bitter character was unknown until discovered by the present inventors.

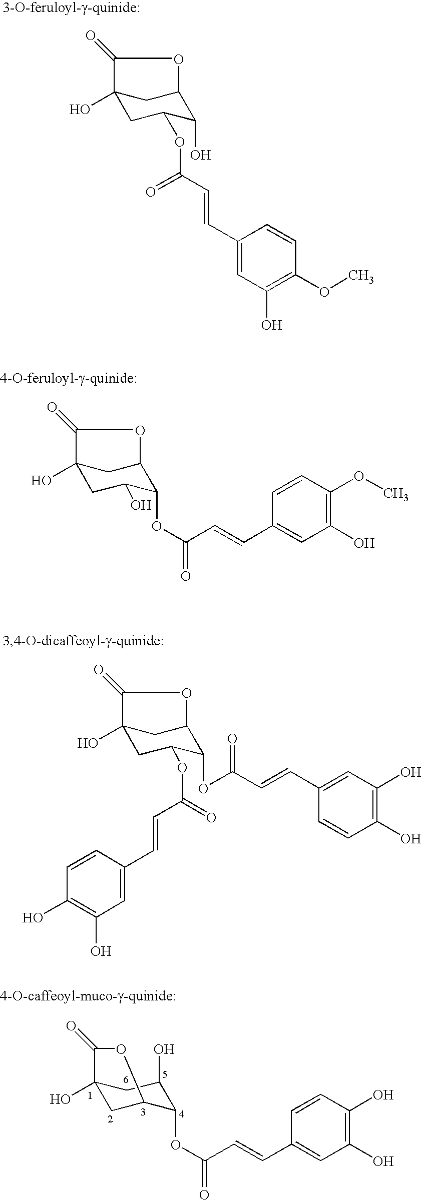

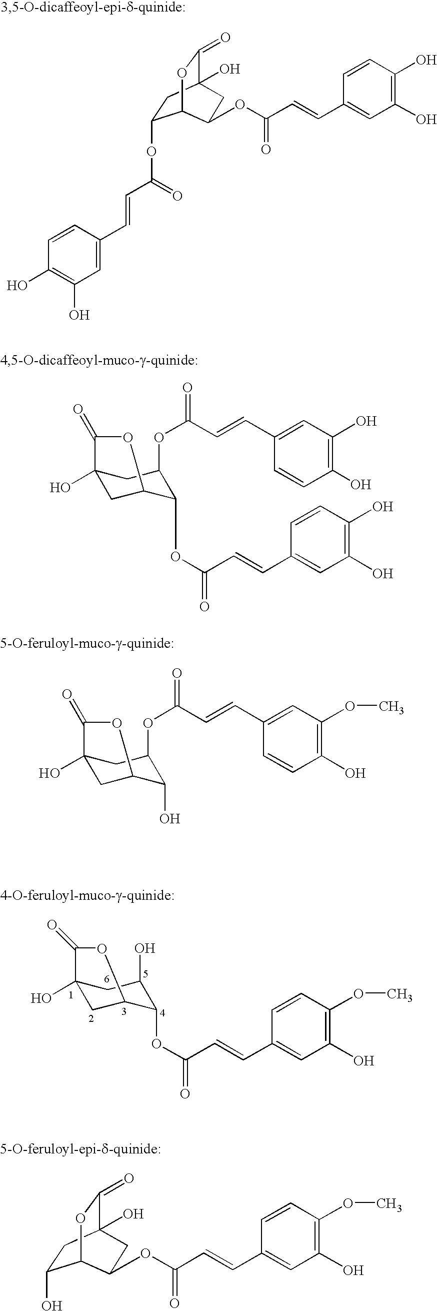

Furthermore, the present inventors have surprisingly discovered a late eluting fraction of even more complex bitter quinides, which have not been previously disclosed. Without intending to be limited by theory, it is believed that this late eluting bitter fraction comprises numerous quinic acid isomers multiply esterified with one or more of caffeic acid, ferulic acid, p-courmaric acid, 2,4-dimethoxycinnamic acid and combinations thereof. Moreover, taste dilution analysis, as well as the calculation of taste activity values, indicates that the compounds comprising this late eluting fraction are the strongest contributors to the unique bitter flavor of coffee.

These exciting discoveries, both the determination of the bitter character of several known compounds, as well as the identification of new varieties of bitter quinides, comprise just one aspect of the present invention. In addition, the present inventors have also surprisingly discovered that when properly isolated, bitter quinides may be added to food and beverage products to enhance the bitter flavor thereof. Without intending to be limited by theory, it is believed that the flavor enhancement resulting from the addition of these bitter quinide isolates to food and beverage products is due to their characteristic roasted coffee-like bitter profile, which cannot be matched by any other known bitter compound (e.g. caffeine, quinine, 2,5-diketopiperazines, L-phenylalanine), and which provides a unique, coffee-specific flavor.

Processes for Isolating Bitter Quinides for Use in Food and Beverage Products

As aforementioned, when isolated properly, the present bitter quinides may be used to enhance the flavor or food and beverage products. Previous attempts to isolate such bitter quinides has generally involved methanol extraction, which results in an isolate unacceptable for use in food and beverage products as methanol is considered to be highly toxic. In contrast, the present inventors have developed processes by which to successfully isolate bitter quinides in a food-grade manner, such that the bitter quinide isolates may be added to food and beverage products.

In general, the present invention teaches processes for isolating bitter quinides for use in food and beverage products comprising contacting a bitter quinide solution with an adsorbent to adsorb bitter quinides from the bitter quinide solution; desorbing the bitter quinides from the adsorbent to obtain a bitter quinide isolate; and adding the bitter quinide isolate to a food or beverage product to enhance the flavor thereof.

Contacting a Bitter Quinide Source with an Adsorbent

Bitter Quinide Solution

The first step of the present process involves contacting a bitter quinide solution with an adsorbent to adsorb the bitter quinides. As used herein, the term “bitter quinide solution” means a solution comprising bitter quinides for use in the processes of the present invention. The bitter quinide solution may comprise at least one roasted chlorogenic acid selected from the group consisting of monocaffeoyl quinic acids, dicaffeoyl quinic acids, tricaffeoyl quinic acids, monoferuloyl quinic acids, diferuloyl quinic acids, triferuloyl quinic acids, quinic acid esterified with one or more of caffeic acid, ferulic acid, p-courmaric acid, 2,4-dimethoxycinnamic acid, and mixtures thereof, derived from natural or synthetic acid sources. The bitter quinide solution may generally have a pH of less than about 7, and in one embodiment, less than about 6, as it has been discovered by the present inventors that at a pH of higher than about 7, the quinide ring has a tendency to start to open and form corresponding acids, which results in a loss of bitter flavor.

As aforementioned, the roasted acids of the bitter quinide solution may be derived from a variety of natural or synthetic acid sources. For example, in one embodiment, the roasted acids of the bitter quinide solution are derived from a natural acid source comprising any plant material comprising chlorogenic acids, such as, for example, green coffee beans, banana leaves, potatoes, and fruits such as apples, pineapples, cherries and peaches. These natural acid sources may first be roasted to convert the chlorogenic acid to bitter quinides, and then the bitter quinides may be extracted. Alternately, the chlorogenic acids may be extracted from the natural acid source and then roasted to convert the acids to bitter quinides. Examples of bitter quinides solutions derived from natural acid sources include, but are not limited to, coffee brew or coffee extract.

Coffee brew comprises a medium strength brewed roast and ground coffee made from about 20 g to about 60 g of roast and ground coffee and about 1000 mL to about 1500 mL of water. Such coffee brew may be produced in a conventional brewer, as well as any other brewing device or appliance known in the art. Coffee extract may be obtained from coffee brew through a variety of extraction methods from, including, but not limited to, direct extraction via the use of solvents, such as mixtures of ethanol and water, or by batch extraction, column extraction or continuous extraction using, for example, a Soxhlet-type extraction unit. Those skilled in the art will understand how to carry out the foregoing extraction procedures. Once the coffee extract is obtained, it may be purified and/or concentrated prior to use in a bitter quinide solution.

The coffee used to make the coffee brew or coffee extract may be derived from any of a number of countries of origin, including, but not limited to, Columbia, Mexico, Guatemala, Brazil or combinations thereof, and it may be caffeinated or decaffeinated. Additionally, the coffee brew or coffee extract may comprise a single variety of coffee, such as Arabica or Robusta, or it may comprise a blend thereof. Moreover, while the coffee used to make the coffee brew or coffee extract may be roasted to any degree using common practices, however, in one embodiment, the coffee comprises light to medium roasts, since it has been found by the present inventors that bitter quinides have a tendency to degrade during prolonged roasting.

In another embodiment, the roasted acids of the bitter quinide solution are derived from a synthetic acid source, such as, for example, synthetic chlorogenic acid.

To roast any of the foregoing acids or acid sources, whether natural or synthetic, comprises roasting under the same general conditions as are employed when roasting green coffee beans. The roasting may be performed at ambient or elevated pressure and the roasting temperature may be constant or follow a desired curve (e.g. ramping). However, when roasting the acids directly, rather than roasting the natural acid source and extracting the roasted acids, it should be noted that the acids may be roasted independently or they may be mixed with an inert material, such as, for example, cellulose, to drive the roasting products in a certain direction. Without intending to be limited by theory, it is believed that if the acids are roasted on their own, the formation of the more complex late eluting fraction may be favoured while if the acids are mixed with an inert material, the formation of mono-quinides may be favoured. In any case, once the roasting is complete, the resulting bitter quinides, which are typically solids after roasting, may be put into solution with solvent to prepare for the next step of contacting with an adsorbent.

Adsorbent

While any adsorbent capable of adsorbing the bitter quinides may be used, because the present invention seeks to produce a bitter quinide isolate acceptable for use in food and beverage products, in one embodiment, the adsorbent comprises a food-grade adsorbent. As used herein, “food-grade” means that the material may legally be used as part of the unit operations of a food process or, that contact with a food is approved by regulatory authorities. Some examples of adsorbents acceptable for use herein include, but are not limited to, polyamide, nylon powder, polyvinyl pyrrolidone, polyvinyl polypyrrolidone, casein, zein or other food-grade resins which adsorb phenolic material, such as Amberlite® XAD, and combinations thereof.

Having selected the adsorbent, the bitter quinide solution may be contacted with the adsorbent in a variety of ways, including, but not limited to, batch extraction or column isolation. Each method is described in more detail below.

When using batch extraction, the adsorbent may be added directly into the bitter quinide solution. Batch extraction may be carried out at any temperature, though in one embodiment, the bitter quinide solution is cooled to about room temperature prior to adding the adsorbent because it is believed that higher temperatures may decrease the overall quinide yield. Also, the amount of time the adsorbent is held in contact with the bitter quinide solution will vary, but generally, from about 5 minutes to about 15 minutes is sufficient time to achieve about 95% adsorption of bitter quinides. Similarly, the amount of adsorbent needed for optimum bitter quinide adsorption will vary according to the adsorbent used. While those skilled in the art will understand how to select the proper condition for carrying out batch extraction, the following is provided for illustration purposes.

As an example, when using polyvinyl pyrrolidone (PVP), the ratio of adsorbent to bitter quinide solution may be about 15 g PVP to about 200 mL bitter quinide solution. This ratio generally results in at least about 95% adsorption of bitter quinides within about 10 minutes. Compare that to using casein as the adsorbent, wherein having a ratio of about 15 g casein to about 200 mL bitter quinide solution typically results in an adsorption of bitter quinides of only about 50%-60%. Thus, in this latter case, it is preferred to use a ratio of casein to bitter quinide solution of about 30 g casein to about 200 mL of bitter quinide solution. Using this latter ratio of casein to bitter quinide solution generally provides adsorption of at least about 80% of the bitter quinides present in the bitter quinide source.

When using column isolation to adsorb the bitter quinides from the bitter quinide solution, a slurry of adsorbent and water is used to fill a column. The column may be any standard isolation column of any size. The adsorbent may then be washed, first by pumping a solvent through the column, then by pumping water through the column. The solvent used herein should be food-grade such that the fractions acquired by the present process are acceptable for use in food and beverage products. Solvents acceptable for use herein may comprise any food-grade solvent including, but not limited to, ethanol, acetone, ethyl acetate and mixtures thereof.

After washing the column with the solvent, a bitter quinide solution may be applied via the top of the column and the bitter quinides, along with any free caffeoyl quinic and free feruloyl quinic acids, are adsorbed by the adsorbent while the residual bitter quinide solution passes through the column, thus effectively separating the bitter quinides and free acids from the residual bitter quinide solution. As used herein, the term “residual bitter quinide solution” means the components of the bitter quinide solution that are not adsorbed by the adsorbent, which generally includes any non-phenolic organic or inorganic material, (e.g. citric acid, quinic acid, malic acid, phosphoric acid), minerals (e.g. sodium, potassium), caffeine, and coffee odorants. One skilled in the art will understand that the amount of bitter quinide solution that can be applied to the column is dependent on the nature and amount of adsorbent present within the column, which in turn, is dependent upon the size of the column. For example, when using polyamide as the adsorbent and coffee brew as the bitter quinide solution, typically about 12-15 mL of coffee brew can effectively be applied to about 1 gram polyamide. Those skilled in the art will understand how to select a column size and adsorbent in view of the foregoing ratio of adsorbent to bitter quinide solution.

Once the bitter quinide solution has been in sufficient contact with the adsorbent to adsorb the bitter quinides and free caffeoyl and feruloyl quinic acids, the adsorbent may be removed from the residual bitter quinide solution if necessary, and washed. If column isolation was used, the adsorbent comprising the bitter quinides was “removed” from the residual bitter quinide solution in the foregoing step, thus there is no further removal to be carried out. However, the adsorbent may be washed by flushing the column with several column volumes of water. If, on the other hand, batch extraction was used, the adsorbent may be filtered off from the residual bitter quinide solution and again, optionally washed with water. Washing with water aids in the removal of any residual bitter quinide solution that may be present on the adsorbent. In both instances, the amount of water used, as well as the number of washing cycles, is not critical as there is very little loss of the desired bitter quinides during this washing process. However, alkaline condition should be avoided due to the instability of the bitter quinides under alkaline conditions.

At this point, the residual bitter quinide solution has a tea-like flavor consisting of sour and astringent flavor attributes with no perceivable bitterness. If so desired, this residual bitter quinide solution may be added to coffee beverages having substantial bitterness, such as, for example, fast roasted Robusta coffees, or lightly roasted coffees, in order to reduce the bitterness thereof. Without intending to be limited by theory, it is believed that when combined with a highly bitter coffee beverage, the residual bitter quinide solution reduces intense bitterness while maintaining other coffee attributes like sourness, caffeine levels, mineral content, thereby resulting in a more balanced blend. While this use of the residual bitter quinide solution is certainly acceptable, the bitter quinides that remain adsorbed by the adsorbent must be processed further before they may be used to enhance the flavor of food and beverage products.

Desorbing the Bitter Quinides from the Adsorbent

Having completed the foregoing steps, the bitter quinides may now be desorbed from the adsorbent to obtain a bitter quinide isolate. Unlike the art, which typically considers any bitter components removed from a coffee brew to be waste material, the present inventors surprisingly discovered that the present bitter isolates may be added to food and beverage products to actually enhance the flavor thereof.

Similar to adsorption, the desorption step may also be carried out via batch extraction or column extraction. For batch extraction, the adsorbent comprising the bitter quinides is re-suspended in a solvent. Solvents acceptable for use herein may comprise any of the aforementioned food-grade solvents capable of selective removal of the bitter quinides from the adsorbent, including, but not limited to, ethanol, acetone and mixtures thereof. Depending on the adsorbent and solvent used, desorption may be performed at various temperature conditions. For example, when using ethanol as the solvent, the solvent may be hot (about 60° C. to about 80° C.) when using PVP as the adsorbent, or room temperature (about 21° C.) when using polyamide and/or casein as the adsorbent. Those skilled in the art will understand how to select the proper temperature according to the adsorbent and solvent used. The adsorbent/solvent mixture is stirred for about 15 minutes to support desorption, after which, the adsorbent is filtered off and a bitter quinide isolate is collected. This process may be repeated several times and the bitter quinide isolates combined.

If using column extraction, the column is flushed with several column volumes of solvent. In this instance, the present inventors surprisingly discovered that the bitter quinide isolate is quantitatively eluted from the adsorbent while other phenolic materials, such as free caffeoyl quinic or feruloyl quinic acids, tend to remain adsorbed on the resin.

Regardless of which method is used to perform the desorption step, the bitter quinide isolate may optionally be further treated. For instance, the bitter quinide isolate may be concentrated under vacuum, such as by rotary evaporation, to a desired strength, or completely dried. Also, the bitter quinide isolate may be further purified by, for example, membrane filtration or solvent extraction, to remove residual odorants, such as 4-vinylguaiacol, which provide smoky notes.

Once the bitter quinide isolate is collected, and optionally further concentrated or purified, it is ready for use in food and beverage products.

Use of the Bitter Quinide Isolate to Enhance the Flavor of Food and Beverage Products

At this point in the process, the bitter quinide isolate is ready for use in food and beverage products to enhance the flavors thereof. In one embodiment, the bitter quinide isolate may comprise at least one compound selected from the group consisting of 3-O-caffeoyl-γ-quinide, 4-O-caffeoyl-γ-quinide, 5-O-caffeoyl-epi-δ-quinide, 5-O-caffeoyl-muco-γ-quinide, 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O -feruloyl-muco-γ-quinide, 5-O-feruloyl-epi-δ-quinide, quinide esterified with one or more of caffeic acid, ferulic acid, p-courmaric acid, 2,4-dimethoxycinnamic acid and mixtures thereof. Such compounds may be derived from roasted natural or synthetic acid sources as described above, or they may be synthesized directly.

As aforementioned, the present bitter quinide isolates may be added to any food or beverage product to provide a unique, coffee-like bitterness. Some of the more common products benefiting from the addition of bitter quinides include, but are not limited to, instant coffee, decaffeinated coffee, roast and ground coffee, ready-to-drink coffee, coffee concentrates, creamy coffees with or without additional flavorants, chocolate milk, chocolate, ice cream and candy. Due to the different ingredients that make up the foregoing products, the bitter quinide isolate may have a different effect on the different food and beverage products to which they are added.

Focusing on the coffee beverage products for a moment, the present inventors have discovered that instant, decaffeinated and dark-roasted roast and ground coffees and coffee beverages, in particular, benefit from the addition of bitter quinide isolates because these products are naturally low in bitter tasting quinides. During instant processing, the quinides are destroyed by the harsh extraction conditions used, while during decaffeination, the acid precursors are partially extracted resulting in lower quinide levels after roasting. Dark roasts contain lesser amounts of bitter quinides compared to light roast because these bitter quinides are formed early in the roasting process and are then destroyed under prolonged roasting conditions. Thus, by adding the bitter quinide isolate of the present invention to such products, the overall flavor of the product may be enhanced to provide a more balanced product. Additionally, the present inventors have found that along with the enhancement in flavor, the general body, strength and mouthfeel of these coffee products is enhanced. The foregoing coffee products may comprise any form, including, but not limited to ready-to-make coffees, ready-to-drink-coffees or concentrated coffees.

Turning to the non-coffee based foods and beverages, such as chocolate, candy and milk, the present inventors have surprisingly found that adding bitter quinide isolates to such products complements the flavors thereof by providing a flavor typical of freshly brewed coffee. Obtaining a good coffee flavor in non-coffee based foods and beverages can be quite difficult as it often involves using a variety of expensive and unstable odorants. In contrast, as the bitter quinide sources described herein are generally readily available, using the bitter quinide isolates of the present invention provides a less expensive, convenient and natural way to flavor a product. In addition, the bitter quinide isolates can provide the unique and characteristic flavor typical of freshly brewed coffee where it may often be difficult to achieve a similar result with currently available flavorants. Moreover, this freshly brewed coffee taste can be provided via the bitter quinide isolates without adding any caffeine to the product. However, it should be noted that the present bitter quinide isolates may indeed be used in conjunction with currently available flavorings to provide a more natural, complex and realistic overall coffee flavor perception.

It will be understood by those skilled in the art that the amount of bitter quinide isolate added to each of the foregoing food and beverage products will differ according to flavor preferences and desired flavor. Representative illustrations of the use of bitter quinide isolates to enhance the flavor of food and beverage products are found herein in the Examples.

### Analytical Methods

Parameters used to characterize elements of the present invention are quantified by particular analytical methods. Those methods are described in detail as follows.

### Method for Evaluating Bitter Quinides Present in a Bitter Quinide Source

Bitter quinides present in a bitter quinide solution are analyzed by HPLC-DAD and HPLC-MS, respectively.

For analysis of the caffeoyl quinic acids, caffeoyl quinides and feruloyl quinic acids, the system consists of a 2695 separation module (Waters, Milford, Mass., USA), a 2996 photometric array detector (Waters, Milford, Mass., USA) and a Micromass ZMD mass spectrometer (provided by Waters, Milford, Mass., USA). Operating in positive electrospray mode, MS-analysis is performed in scan and single-ion-monitoring mode using m/z=355 for the caffeoylquinic acids, m/z=337 for the caffeoyl quinides, and m/z=369 for feruloylquinic acids. For illustration purposes only, coffee brew is used though it will be understood that any bitter quinide solution may be employed. 10 ul of coffee brew is directly injected onto an analytical Phenyl-Hexyl column (250 ×4.6 mm, Luna, Phenomenex, Torrance, Calif., USA) kept at 40° C. Maintaining a flow rate of 0.8 mL/min and monitoring the effluent at 326 nm, chromatography is performed starting with a mixture (75/25, v/v) of aqueous ammonium formate buffer (250 mmol, pH 3.5) and methanol, thereafter increasing the methanol content to 30% within 30 min, then to 50% within 15 min, and finally to 100% within 10 min. This methanol content is maintained for additional 10 min. Under these conditions, the free caffeoylquinic acids typically elute after 6.07 minutes, 8.53 minutes and 8.71 minutes, the feruloylquinic acids elute after 16.30 minutes and 16.78 minutes, the five caffeoylquinides elute after 17.4 minutes, 18.1 minutes, 19.1 minutes, 20.2 minutes and 22.3 minutes, as discrete peaks. In addition, a highly complex and intensely bitter tasting late eluting fraction comprising numerous multiply esterified quinic acid isomers elutes as one complex peak between 50 minutes and 56 minutes.

For analysis of the di-caffeoylquinides as well as the feruloyl quinides, an Agilent 1100 series HPLC (Agilent, Palo Alto, Calif., USA) is coupled to a API 4000 Q-Trap mass spectrometer (Applied Biosystems, Darmstadt, Germany) operating in the multiple reaction monitoring mode (MRM) for detecting negative ions. For a duration of 150 ms, the mass transition reactions m/z 497→335 and 497→161 are used for the detection of di-caffeoyl quinides, and m/z 349→193 and 349→175 for the feruloyl quinides. Zero grade air serves as nebulizer gas (35 psi) and as turbo gas (400° C.) for solvent drying (45 psi).

For monitoring the individual dicaffeoyl quinides, chromatography is performed on an analytical column (Synergi Fusion-RP, 150×2 mm i.d., 4 μm, Phenomenex, Aschaffenburg, Germany). After injection of the sample (10 μL), analysis is performed using a gradient, starting with a mixture (85/5, v/v) of aqueous TFA (0.05%) and methanol, and increasing the methanol content to 40% within 25 min, and then to 100% within 15 min while maintaining a flow rate of 250μL/min.

For monitoring individual feruloyl quinides, chromatography is performed on an analytical Phenyl-Hexyl column (250×4.6 mm, Luna, Phenomenex, Torrance, Calif., USA). After injection of the sample (10 μL), chromatography is performed starting with a mixture (75/25, v/v) of aqueous ammonium formate buffer (500 mmol, pH 3.5) and methanol, thereafter increasing the methanol content to 28% within 34.5 min, then to 50 % within 10 min, and finally to 100% within 5 min while maintaining a flow rate of 1.0 mL/min.

### EXAMPLES

### Example 1

About 500 grams of polyamide (SC-6, Machery & Nagel, Easton, Pa.) is suspended in about 1500 mL of water and allowed to swell for about 2 hours at about room temperature. Fines floating on the surface are removed and the slurry is filled into a XK 50/100 column (100 cm×5.0 cm; Amersham Pharmacia, Piscataway, N.J.) until a column bed height of about 90 cm is obtained. Using Tefzel® tubing (Amersham Pharmacia, Piscataway, N.J.) and Masterflex® silicone tubing (size 16; Cole Palmer, Chicago, Ill.) the column is connected to a peristaltic pump (Baker Technical Industries.) To remove any impurities, the column is flushed with 200 proof ethanol (Aaper, Shelbyville, Ky.) for 8 hours at a flow rate of about 14.73 mL/min. Subsequently, the mobile phase is switched to water and the column continues to be flushed for approximately 12 additional hours.

About six liters of coffee brew is prepared in batches containing about 50 g roast & ground coffee (Folgers® Gourmet Supreme decaf) and 1100 mL of water using a coffee maker. The coffee brew is then cooled to about room temperature in an ice bath. About 5 liters of the coffee brew is applied to the column at a flow rate of about 14.5 mL/min, and then the column is washed with water (Milli-Q®) for about 12 hours. Finally, the mobile phase is switched to 200 proof ethanol (Aaper, Shelbyville, Ky.) and after the aqueous dead volume of the column (about 1.4 liters) is pumped from the column, the ethanolic effluent containing the bitter quinide isolate is collected. After collecting about 5.61 liters of the isolate, which is the equivalent of about four column volumes, isolation is stopped. The ethanol is removed from the isolate by rotary evaporation (Buechi, New Castle, Del.) conducted at about 40° C. and about 70 mbar and the remaining dry residue of the bitter quinide isolate is dissolved in about 50 mL of 200 proof ethanol (Aaper, Shelbyville, Ky.). Any insoluble material is removed by centrifugation. The bitter quinide isolate is analyzed using the Analytical Methods described herein and is found to comprise bitter quinides acceptable for use in food and beverage products.

### Example 2

About 1 gram of chlorogenic acid (Aldrich, Milwaukee, Wis.) and about 2 mL of water (Milli-Q®) are mixed and subsequently dried at about 70° C. The residues are then dry-heated for about 18 minutes at from about 220-230° C. The resulting reaction products are dissolved in hot water (Milli-Q®, 100 mL) and after cooling to about room temperature, are extracted with ethyl acetate (5×25 mL, Aldrich, Milwaukee, Wis.). The combined organic layers are freed from solvent and the residues are taken up in ethanol/water (30/70, v/v; 10 mL) for further processing.

In case residual chlorogenic acid needs to be removed, polyamide (MN-SC-6, Machery & Nagel, Easton, Pa.) is suspended in water and filled in a glass column (300×30 mm) up to about 160 mm. The polyamide is conditioned with a mixture of about 250 mL of ethanol and about 250 mL of water and the residues dissolved in water (Milli-Q) are applied to the column. The column is washed with about 750 mL of water and the bitter quinides are eluted using about 500 mL of ethanol. Finally, the ethanolic bitter isolate is concentrated by rotary evaporation in vacuum (45° C., 70 mbar) to a desired strength. The bitter quinide isolate is analyzed using the Analytical Methods described herein and is found to comprise bitter quinides acceptable for use in food and beverage products.

### Example 3

About 0.250-0.5 mL of the ethanolic bitter quinide isolate of Example 1 (the equivalent to about 25-50 mg dry weight) is dried under a stream of nitrogen and subsequently dissolved in about 100 mL instant coffee beverage prepared from about 1.5 g of Folgers® instant coffee and about 100 mL water. When compared to an instant coffee beverage without the added bitter quinide isolate, the instant coffee beverage having the added bitter quinide isolate has an enhanced, freshly brewed coffee flavor combined with increased body and strength while the hydrolyzed off-note, which is typical for instant coffee, is decreased. Overall, the instant coffee beverage supplemented with the bitter quinide isolate is perceived to be much closer in taste to a freshly brewed coffee.

### Example 4

About 0.1-0.25 mL of the ethanolic bitter quinide isolate from Example 1 (the equivalent to about 10-25 mg dry weight) is dried under a stream of nitrogen and subsequently dissolved in about 100 mL of freshly brewed roast and ground decaffeinated coffee prepared using about 33.3 g of Folgers Gourmet Supreme® & decaf coffee and about 1420 mL of water. A comparison to decaffeinated coffee not supplemented with the bitter quinide isolate shows that the coffee having the added bitter isolate has increased strength and body and an improved mouthfeel.

### Example 5

About 50 g of milk chocolate (Milka®) is melted over a hot water bath and about 0.6 mL (about 60 mg dry weight) of the ethanolic bitter isolate from Example 1 is added and distributed evenly by stirring. The chocolate/bitter isolate combination is then transferred into a crystallization bowl and placed into a refrigerator to harden for about 30 minutes. The chocolate, now having the added bitter quinide isolate, displays a character similar to dark chocolate, good coffee flavor and good coffee-like mouthfeel.

### Example 6

About 15 g of Nesquick® double chocolate cocoa powder (Nestle) is dissolved in about 235 mL milk and heated in a microwave. Then about 300 ul of the ethanolic bitter isolate from Example 1 (the equivalent to about 30 mg dry weight) is added to the hot beverage with stirring to enhance the flavor thereof. The enhanced chocolate milk displays good coffee flavor and good coffee like mouthfeel.

All documents cited in the present specification are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for isolating bitter quinides for use in food and beverage products comprising:
a. contacting a bitter quinide solution with an adsorbent to adsorb bitter quinides from the bitter quinide solution;
b. desorbing the bitter quinides from the adsorbent to obtain a bitter quinide isolate; and
c. adding the bitter quinide isolate to a food or beverage product to enhance the flavor thereof.

2. The process of claim 1 wherein the bitter quinide solution comprises at least one roasted chlorogenic acid derived from a natural or synthetic acid source.

3. The process of claim 1 wherein the bitter quinide solution is coffee brew, coffee extract, or mixtures thereof.

4. The process of claim 2 wherein the natural acid source is a plant material comprising chlorogenic acid.

5. The process of claim 1 wherein the adsorbent is selected from the group consisting of polyamide, nylon powder, polyvinyl pyrrolidone, polyvinyl polypyrrolidone, casein, zein, Amberlite® XAD, natural or synthetic polymers containing amide groups and combinations thereof.

6. The process of claim 1 wherein the bitter quinide isolate comprises at least one compound selected from the group consisting of 3-O-caffeoyl-γ-quinide, 4-O-caffeoyl-γ-quinide, 5-O-caffeoyl-epi-δ-quinide, 5-O-caffeoyl-muco-γ-quinide, 3-O-feruloyl-γ-quinide, 4-O-feruloyl-γquinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-muco-γ-quinide, 5-O-feruloyl-epi-δ-quinide, quinide esterified with one or more of caffeic acid, ferulic acid, p-courmaric acid, 2,4-dimethoxycinnamic acid and mixtures thereof.

7. The process of claim 1 wherein the desorbing is carried out using a solvent selected from the group consisting of ethanol, acetone and mixtures thereof.

8. The process of claim 2 wherein the bitter quinide solution has a pH of less than about 7.

9. The process of claim 2 wherein the adsorbent is polyvinylpyrrolidone.

10. The process of claim 8 wherein the bitter quinide isolate comprises at least one compound selected from the group consisting of 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-γ-quinide, 5-O-feruloyl-epi-δ-quinide, quinide esterified with one or more of caffeic acid, ferulic acid, p-courmaric acid, 2,4-dimethoxycinnamic acid and mixtures thereof.

11. The process of claim 4 wherein the natural acid source is a plant material selected from the group consisting of coffee beans, banana leaves, potatoes, apples, pineapples, cherries, peaches and combinations thereof.

12. The process of claim 8 wherein the bitter quinide solution has a pH of less than about 6.

13. The process of claim 8 wherein the desorbing is carried out using ethanol.

14. The process of claims 1 wherein the bitter quinide isolate is used to enhance the flavor of a food or beverage product selected from the group consisting of instant coffee, decaffeinated coffee, roast and ground coffee, ready-to-drink coffee, coffee concentrates, creamy coffees with or without additional flavors, chocolate milk, chocolate, ice cream and candy.

15. The process of claim 10 wherein the bitter quinide isolate comprises at least one compound selected from the group consisting of quinide esterified with one or more of caffeic acid, ferulic acid, p-courmaric acid, 2,4-dimethoxycinnamic acid, combinations thereof and mixtures thereof.

16. The process of claim 2 wherein the bitter quinide isolate is concentrated, purified or both, prior to being used to enhance the flavor of a food or beverage product.

17. A bitter quinide isolate for enhancing flavor of food and beverage products comprising at least one compound selected from the group consisting of 3-O-caffeoyl-γ-quinide, 4-O-caffeoyl-γ-quinide, 5-O-caffeoyl-epi-δ-quinide, 5-O-caffeoyl-muco-γ-quinide, 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-muco-γ-quinide, 5-O-feruloyl-epi-δ-quinide, quinide esterified with one or more of caffeic acid, ferulic acid, p-courmaric acid, 2,4-dimethoxycinnamic acid and mixtures thereof.

18. The bitter quinide isolate of claim 17 comprising at least one compound selected from the group consisting of 3-O-feruloyl-γ-quinide, 4-O-feruloyl-γ-quinide, 3,4-O-dicaffeoyl-γ-quinide, 4-O-caffeoyl-muco-γ-quinide, 3,5-O-dicaffeoyl-epi-δ-quinide, 4,5-O-dicaffeoyl-muco-γ-quinide, 5-O-feruloyl-muco-γ-quinide, 4-O-feruloyl-muco-γ-quinide, 5-O-feruloyl-epi-δ-quinide, quinide esterified with one or more of caffeic acid, ferulic acid, p-courmaric acid, 2,4-dimethoxycinnamic acid and mixtures thereof.

19. The bitter quinide isolate of claim 17 wherein the bitter quinide isolate is used to enhance the flavor of a food or beverage product selected from the group consisting of instant coffee, decaffeinated coffee, roast and ground coffee, ready-to-drink coffee, coffee concentrates, creamy coffee with or without additional flavors, chocolate milk, chocolate, ice cream and candy.

20. The bitter quinide isolate of claim 17 wherein the bitter quinide isolate is used to enhance the flavor of a beverage product selected from the group consisting of instant coffee, decaffeinated coffee, roast and ground coffee, ready-to-drink coffee, coffee concentrates, and mixtures thereof.
